(19) United States
(12) Patent Application Publication
(10) Pub. No.: US 2026/0050877 A1
(43) Pub. Date: Feb. 19, 2026

(54) METHOD AND SYSTEM FOR ESTIMATING A TIME OF ARRIVAL OF A DRIVER AT A LOCATION

(71) Applicant: GRABTAXI HOLDINGS PTE. LTD., Singapore (SG)

(72) Inventors: Xiaojie SU, Chaoyang District, Beijing (CN); Ju CUI, Chaoyang District, Beijing (CN); Kai CHEN, Chaoyang District, Beijing (CN); Xue PAN, Chaoyang District, Beijing (CN); Siyuan LIN, Chaoyang District, Beijing (CN)

(21) Appl. No.: 19/103,670

(22) PCT Filed: Aug. 28, 2023
(86) PCT No.: PCT/SG2023/050585

§ 371 Date: Feb. 13, 2025

(30) Foreign Application Priority Data
Sep. 5, 2022 (WO) PCT/CN2022/117044

(51) Int. Cl. G06Q 10/0833; H04W 4/02; H04W 4/021; H04W 4/024

(52) U.S. Cl. CPC G06Q 10/0833; H04W 4/021; H04W 4/023; H04W 4/024

(57) ABSTRACT

The present disclosure provides methods and systems for estimating a time of arrival of a driver at a location. In some examples, there is provided a method comprising: defining, by a server, a search area divided into a plurality of cells, the search area having a location as a centre point of the search area, the location being indicated in a request for a driver from a requestor device, the requestor device being a computing device associated with a user; determining, by the server, a number of provider devices located in each cell of the plurality of cells based on a location of each provider device of a plurality of provider devices, each provider device being a computing device associated with a driver located within the search area; and estimating, by the server in real time and in response to the request for a driver, a time of arrival of a driver at the location based on a relative distance between the location and the plurality of cells based on the determined number of provider devices.

### FIELD OF INVENTION

The present disclosure relates broadly, but not exclusively, to methods and systems for estimating a time of arrival of a driver at a location.

### BACKGROUND

An Upfront Estimated Time of Arrival (ETA) is typically used by ride-hailing or delivery platforms to show, upon receiving a booking from a user, how soon a driver can be assigned and then be able to come pick up the user. In the delivery scenario, Upfront ETA is included on the order listing page as part of the total estimated delivery time from allocation to picking up an order and to dropping up to the eater's place, for example as shown in references 302 and 304 in illustration 300 of FIG. 3. It shows the user an estimation at a pre-booking phase for not only the road condition near a pickup location, but also the surrounding drivers' supply situation.

One typical solution for estimating a time of arrival is to first find a list of available nearby drivers, and then calculate the estimated time of arrival from each driver's current location to the pickup location, and finally return the shortest time as the result. However, this solution is computationally costly because it requires 1) a storage for drivers' real time location updates and a K-nearest neighbor search, as well as 2) a map engine and a cache layer to calculate point-to-point ETAs. Both requirements utilize spatial indexes within a search radius which is usually 5 km. The spatial index needs to handle high QPS which requires fast and frequent access, such that existing solutions like R tree would not be ideal.

Further, indexes based on Space Filling Curve need to encode an identifier which would take at least 8 bytes for each origin or destination of the various combinations of the point-to-point ETA cache, causing high storage consumption. In addition, an estimated shortest time may be an underestimate, which could cause passenger cancellations as a result of waiting too long for a driver. Another solution is to use a static value as part of merchant commitment, but it does not reflect the dynamic nature of driver supply on the market.

A need therefore exists to provide methods and systems that seek to overcome or at least minimize the above mentioned challenges.

### SUMMARY

According to a first aspect of the present disclosure, there is provided a method for estimating a time of arrival of a driver at a location, the method comprising: defining, by a server, a search area divided into a plurality of cells, the search area having a location as a centre point of the search area, the location being indicated in a request for a driver from a requestor device, the requestor device being a computing device associated with a user; determining, by the server, a number of provider devices located in each cell of the plurality of cells based on a location of each provider device of a plurality of provider devices, each provider device being a computing device associated with a driver located within the search area; and estimating, by the server in real time and in response to the request for a driver, a time of arrival of a driver at the location based on a relative distance between the location and the plurality of cells based on the determined number of provider devices.

According to a second aspect of the present disclosure, there is provided a system for estimating a time of arrival of a driver at a location, comprising: at least one processor; and at least one memory including computer program code; the at least one memory and the computer program code configured to, with the at least one processor, cause the system at least to: define a search area divided into a plurality of cells, the search area having a location as a centre point of the search area, the location being indicated in a request for a driver from a requestor device, the requestor device being a computing device associated with a user; determine a number of provider devices located in each cell of the plurality of cells based on a location of each provider device of a plurality of provider devices, each provider device being a computing device associated with a driver located within the search area; and estimate, in real time and in response to the request for a driver, a time of arrival of a driver at the location based on a relative distance between the location and the plurality of cells based on the determined number of provider devices.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for estimating a time of arrival of a driver at a location according to various embodiments of the present disclosure.

FIG. 2 is a schematic diagram of an estimation server, according to various embodiments of the present disclosure.

FIG. 3 depicts an illustration of how an Upfront Estimated Time of Arrival (ETA) may be shown to a user via an interface of a platform according to an example.

FIG. 4 illustrates an overview of a system for estimating a time of arrival of a driver at a location according to various embodiments.

FIG. 5 illustrates an example algorithm for a breadth-first search according to various embodiments.

FIG. 6A illustrates a search area in a grid format according to various embodiments.

FIG. 6B illustrates a search area in a circle format according to various embodiments.

FIG. 7 illustrates an example flow diagram for estimating a time of arrival of a driver at a location according to various embodiments.

FIG. 8A is a schematic block diagram of a general purpose computer system upon which the estimation server of FIG. 2 can be practiced.

FIG. 8B is a schematic block diagram of a general purpose computer system upon which a combined transaction processing and estimation server of FIG. 1 can be practiced.

FIG. 9 shows an example of a computing device to realize the transaction processing server shown in FIG. 1.

FIG. 10 shows an example of a computing device to realize the estimation server shown in FIG. 1.

FIG. 11 shows an example of a computing device to realize a combined transaction processing and estimation server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (e.g., associated with a requestor of a product or service) and a provider device (e.g., associated with a provider of the product or service). For example, a platform may offer a service offered by a provider such as a ride, delivery, online shopping, insurance, and other similar services to a requestor. A requestor can typically access the platform via a website, an application, or other similar methods using the requestor device. In the present disclosure, the provider device may be associated with a driver who may provide a ride or delivery that is requested by a requestor.

A location is one that a user may indicate or search for in a transport or delivery booking service. The location may be a place at which the user may be interested in going or delivering something. It may also be a location at which the user wants to be picked up by a driver (e.g. a pick up point) or at which the driver is to retrieve an item for or deliver an item to the user. In a request for a driver that may be sent from the user to the transport or delivery booking service, a location at which the user wants to begin the ride or send a delivery may be indicated as the location. The location may be provided in the form of Global Positioning System (GPS) information, latitudinal and longitudinal coordinates, geohash information, and other similar information.

Based on the indicated location, a search area may be defined for the purposes of searching for nearby drivers who may be able to provide the requested ride or delivery (e.g., searching for drivers who are located within the search area). The search area may have the location as the centre point and spanning a distance from the centre point. For example, the search area may be in a form of a grid with the location at the centre, wherein the grid may be a square, rectangle, polygon or other similar shape. The grid may also be in a form of a circle with the location at the centre. The search area may be divided into cells. Each cell may be identified by a corresponding identifier (ID), for example based on a relative distance, position and/or radius (e.g., in the case where the search area is a circle) from the centre of the search area. When searching for available drivers within the search area, information indicating a location of a driver (e.g., GPS information, latitudinal and longitudinal coordinates, geohash information, or other similar information), a status of the driver (e.g., available, unavailable, handling another request, finishing a request soon, or other similar statuses), and other similar information may be retrieved from a provider device of each driver that is located within the search area.

In at least some embodiments, a user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing server will be called a registered user. A user who is not registered to the transaction processing server will be called a non-registered user. The term user will be used to collectively refer to both registered and non-registered users. A user may interchangeably be referred to as a requestor (e.g. a person who requests for a product or service) or a provider (e.g. a person who provides the requested product or service to the requestor).

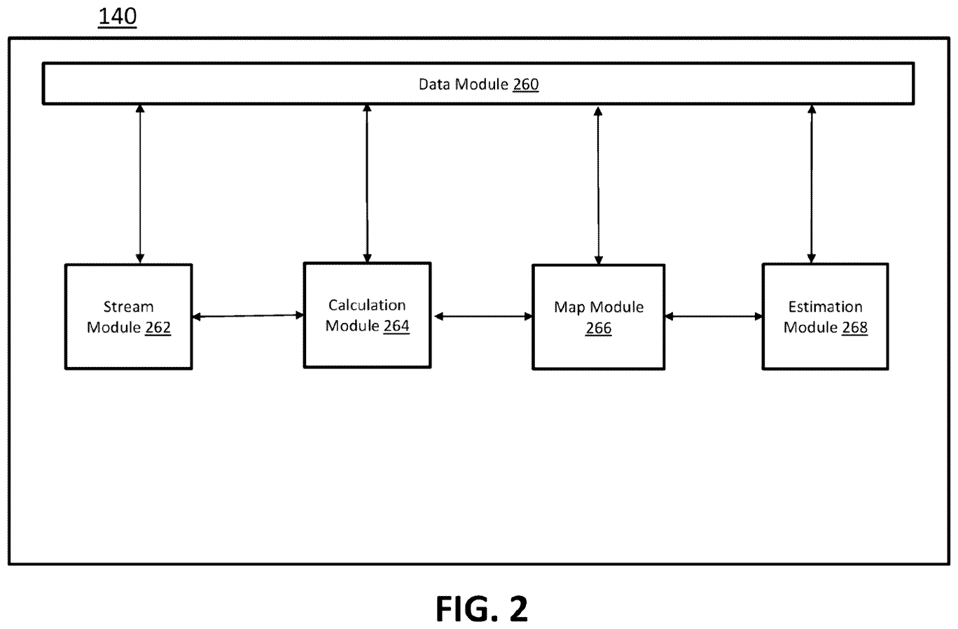

In at least some embodiments, an estimation server is a server that hosts software application programs for estimating a time of arrival of a driver at a location. The estimation server may be implemented as shown in schematic diagram 200 of FIG. 2 for estimating a time of arrival of a driver at a location.

In at least some embodiments, a transaction processing server is a server that hosts software application programs for processing payment transactions for, for example, a request for a driver, a travel-ordination request, purchasing of a good or service by a user, and other similar services. The transaction processing server communicates with any other servers (e.g., an estimation server) concerning processing payment transactions relating to the purchasing of the good or service, such as a request for a driver (which may be referred to interchangeably as a request for a ride, delivery, or other similar service that requires a driver). For example, data relating to a request message such as a request for a driver (e.g. date, time, a location, and other similar data) may be provided to the estimation server and processed to locate drivers that are in proximity to the location. The transaction processing server may use a variety of different protocols and procedures in order to process the payment and/or driver requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g. a company or organization) which operates to process transaction requests and/or driver requests e.g. pair a driver to a requestor of the driver request. The transaction processing server may include one or more computing devices that are used for processing transaction requests and/or driver requests.

In at least some embodiments, a transaction account is an account of a user who is registered at a transaction processing server. The user can be a customer, a merchant providing a product for sale on a platform and/or for onboarding the platform, a ride or delivery provider (e.g., a driver), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “identifying”, “detecting”, “grouping”, “determining”, “associating”, “selecting”, “calculating”, “processing”, “storing”, “indicating”, “discerning”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In the present disclosure, stream aggregation is utilized to replace K-nearest neighbor search which is typically used for searching a plurality of drivers in a search area. The whole search area within radius is divided into small cells. Instead of storing and updating each driver's exact ID and location, a sum of drivers in each cell is stored instead for usage as an approximation of driver distributions in real time. This can advantageously save up to 80% of computational cost compared to computing a K-nearest neighbor.

Further, point-to-point ETA cache is replaced with two novel spatial indexes, so that estimation of a time of arrival of a driver at a location is based on these indexes. Within a radius of the search area, cells are organized depending on the shape of the index, and each cell is indexed based on its relative position to the centre of the search area. Advantageously, utilizing these spatial indexes over point-to-point ETA cache enables the system to save more storage space. For example, using stream aggregation combined with index-based ETA reduces storage space to 62.5% compared to point-to-point ETA cache. The final ETA may then be calculated as a weighted average on all cells, or a certain percentile after sorting all ETA results in ascending order.

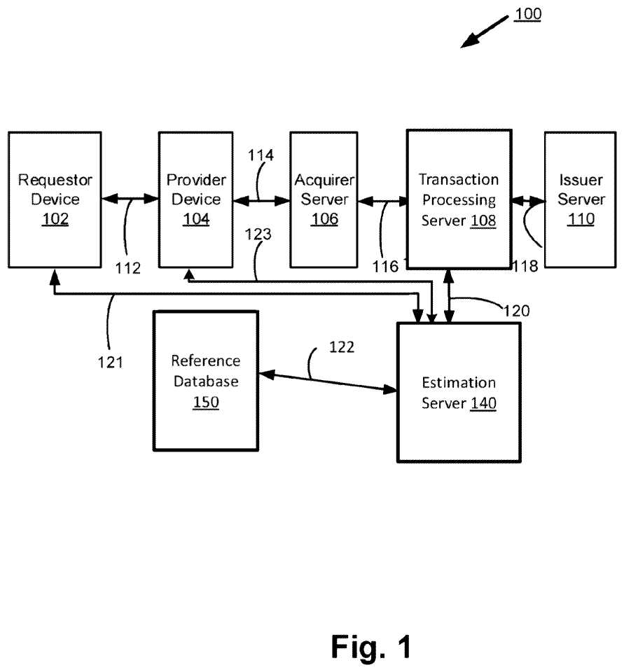

FIG. 1 illustrates a block diagram of an example system 100 for estimating a time of arrival of a driver at a location. In some embodiments, the system 100 enables a payment transaction for a good or service, and/or a request for a driver e.g., for a ride or delivery of a physical item (e.g. one or more food items or a parcel) between a requestor and a provider.

The system 100 comprises a requestor device 102, a provider device 104, an acquirer server 106, a transaction processing server 108, an issuer server 110, an estimation server 140 and a reference database 150.

The requestor device 102 is in communication with a provider device 104 via a connection 112, and may be associated with a user. The connection 112 may be wireless (e.g., via NFC communication, Bluetooth, etc.) or over a network (e.g., the Internet). The requestor device 102 is also in communication with the estimation server 140 via a connection 121, wherein the estimation server 140 may be configured to receive information relating to a request for a driver (e.g. information such as a location at which a driver is required, information identifying the user and/or requestor device 102 sending the request, and other similar information) from the requestor device 102. The connection 121 may be via a network (e.g., the Internet). The requestor device 102 may also be connected to a cloud that facilitates the system 100 for estimating a time of arrival of a driver at a location. For example, the requestor device 102 can send a signal or data to the cloud directly via a wireless connection (e.g., via NFC communication, Bluetooth, etc.) or over a network (e.g., the Internet). It will be appreciated that there can be a plurality of requestor devices 102 such that each requestor device 102 is associated with a respective user.

The provider device 104 is in communication with the requestor device 102 as described above, usually via the transaction processing server 108, and may be associated with a provider of a ride or delivery (e.g. a driver responding to the request for a driver). The provider device 104 is, in turn, in communication with an acquirer server 106 via a connection 114. The provider device 104 is also in communication with the estimation server 140 via a connection 123, wherein the estimation server 140 may be configured to receive information relating to a location of a driver (e.g., GPS information, latitudinal and longitudinal coordinates, geohash information, or other similar information), a status of the driver (e.g., available, unavailable, handling another request, finishing a request soon, or other similar statuses), identification information relating to the driver and/or provider device 104, and other similar information from the provider device 104. The connections 114 and 123 may be via a network (e.g., the Internet). The provider device 104 may also be connected to a cloud that facilitates the system 100 for estimating a time of arrival of a driver at a location. For example, the provider device 104 can send a signal or data to the cloud directly via a wireless connection (e.g., via NFC communication, Bluetooth, etc.) or over a network (e.g., the Internet). It will be appreciated that there can be a plurality of provider devices 104 such that each provider device 104 is associated with a respective driver.

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the estimation server 140 via a connection 120. The connection 120 may be over a network (e.g., a local area network, a wide area network, the Internet, etc.). In one arrangement, the transaction processing server 108 and the estimation server 140 are combined and the connection 120 may be an interconnected bus.

The estimation server 140, in turn, is in communication with the reference database 150 via respective connection 122. The connection 122 may be over a network (e.g., the Internet). The estimation server 140 may also be connected to a cloud that facilitates the system 100 for estimating a time of arrival of a driver at a location. For example, the estimation server 140 can send a signal or data to the cloud directly via a wireless connection (e.g., via NFC communication, Bluetooth, etc.) or over a network (e.g., the Internet).

The reference database 150 may comprise data that is utilized by the estimation server 140 for estimating a time of arrival of a driver at a location. For example, data relating to the search area, sum of drivers associated with each cell in the search area, and other similar information required for estimating a time of arrival of a driver at a location may be processed and stored in the reference database 150. The reference database 150 may also comprise data relating to maps, as well as location information relating to geographical areas, buildings, road networks, and other similar entities that may facilitate estimating a time of arrival of a driver at a location. In an implementation, the reference database 150 may be combined with the estimation server 140. In an example, the reference database 150 may be managed by an external entity.

The estimation server 140 may be configured to define, based on a location indicated in a request for a driver from the requestor device 102, a search area divided into a plurality of cells, the search area having the location as a centre point of the search area. The estimation server 140 may also determine a number of provider devices 104 located in each cell of the plurality of cells based on a location of each provider device of a plurality of provider devices 104. The estimation server 140 may further estimate, in real time and in response to the request for a driver, a time of arrival of a driver at the location based on a relative distance between the location and the plurality of cells based on the determined number of provider devices 104.

Estimating the time of arrival of the driver at the location may further comprise identifying one or more cells of the plurality of cells based on the relative distance and a threshold, wherein a total number of provider devices 104 located in the one or more cells do not exceed the threshold.

In an implementation, there may be more than one reference databases, in which the estimation server 140 may be configured to determine which database to use for each step during the process of estimating a time of arrival of a driver at a location. Alternatively, one or more modules may store the above-mentioned data instead of the reference database 150, wherein the module may be integrated as part of the estimation server 140 or external from the estimation server 140.

In the illustrative embodiment, each of the devices 102, 104, and the servers 106, 108, 110, 140, and/or reference database 150 provides an interface to enable communication with other connected devices 102, 104 and/or servers 106, 108, 110, 140, and/or reference database 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 to send data relating to a request for a driver such as a location at which the driver is required, and for the provider device 104 to send data relating to a location or a status of an associated driver, in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The estimation server 140 is associated with an entity (e.g. a company or organization or moderator of the service). In one arrangement, the estimation server 140 is owned and operated by the entity operating the transaction processing server 108. In such an arrangement, the estimation server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the estimation server 140. The user may be a requestor or a provider associated with the requestor device 102 or the provider device 104, respectively.

Details of the registration may include, for example, name of the user, address of the user, emergency contact, blood type or other healthcare information, next-of-kin contact, permissions to retrieve data and information from the requestor device 102 and/or the provider device 104 for estimating a time of arrival of a driver at a location, such as permission to retrieve location and status information from the requestor device 102 and/or the provider device 104. Alternatively, another mobile device may be selected instead of the requestor device 102 and/or the provider device 104 for retrieving the data. Once on-boarded, the user would have a transaction account that stores all the details.

The requestor device 102 is associated with a user (or requestor) who is a party to a transaction that occurs between the requestor device 102 and the provider device 104, or between the requestor device 102 and the estimation server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a user who initiates a request for a driver.

The requestor device 102 includes transaction credentials (e.g., a payment account) of a requestor to enable the requestor device 102 to be a party to a payment transaction. If the requestor has a transaction account, the transaction account may also be included (i.e., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request. The user uses the watch or similar wearable to make request regarding the transaction request by pressing a button on the watch or wearable.

The provider device 104 is associated with a provider who is also a party to the transaction request or request for a driver that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with a provider of a ride or delivery (e.g. a driver responding to the request for a driver).

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a driver, travel co-ordinator or merchant) associated with the provider.

If the provider has a transaction account, the transaction account may also be included (i.e., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make request regarding the transaction request by pressing a button on the watch or wearable.

The acquirer server 106 is associated with an acquirer who may be an entity (e.g. a company or organization) which issues (e.g. establishes, manages, administers) a payment account (e.g. a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request or a request for a ride to the transaction processing server 108.

The transaction processing server 108 is configured to process processes relating to a transaction by, for example, forwarding data and information associated with the transaction to the other servers in the system 100 such as the estimation server 140. In an example, the transaction processing server 108 may, instead of the requestor device 102 or provider device 104, transmit data relating to a request message such as a request for a driver (e.g. date, time, a location, and other similar data) to the estimation server 104. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods.

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g. a company or organization) which manages (e.g. establishes, administers) data relating to users, transactions, products, services, and other similar data, for example relating to the entity. In an arrangement, the reference database 150 may comprise data that is utilized by the estimation server 140 for estimating a time of arrival of a driver at a location. For example, data relating to the search area, sum of drivers associated with each cell in the search area, and other similar information required for estimating a time of arrival of a driver at a location may be processed and stored in the reference database 150. The reference database 150 may also comprise data relating to maps, as well as location information relating to geographical areas, buildings, road networks, and other similar entities that may facilitate estimating a time of arrival of a driver at a location. In an implementation, the reference database 150 may be combined with the estimation server 140. In an example, the reference database 150 may be managed by an external entity.

Advantageously, the system 100 enables ETA estimation based on sum numbers of drivers in each cell and relative location from each non-empty cell to a location, instead of computing based on point-to-point ETAs, thus significantly reducing computational cost for ETAs.

FIG. 2 illustrates a schematic diagram of an example estimation server 140 according to various embodiments. The estimation server 140 may comprise a data module 260 configured to receive data and information from the requestor device 102, provider device 104, transaction processing server 108, reference database 150, a cloud and other sources of information to estimate a time of arrival of a driver by the estimation server 140. For example, the data module 260 may be configured to receive data and information required for processing stream information, defining search areas, perform arrival time estimation calculations, and other similar processes from the requestor device 102, the provider device 104, transaction processing server 108, reference database 150, and/or other sources of information. The data module 260 may be further configured to send information relating to data retrieved in response to the request for a driver to the requestor device 102, the provider device 104, the transaction processing server 108, or other destinations where the information is required.

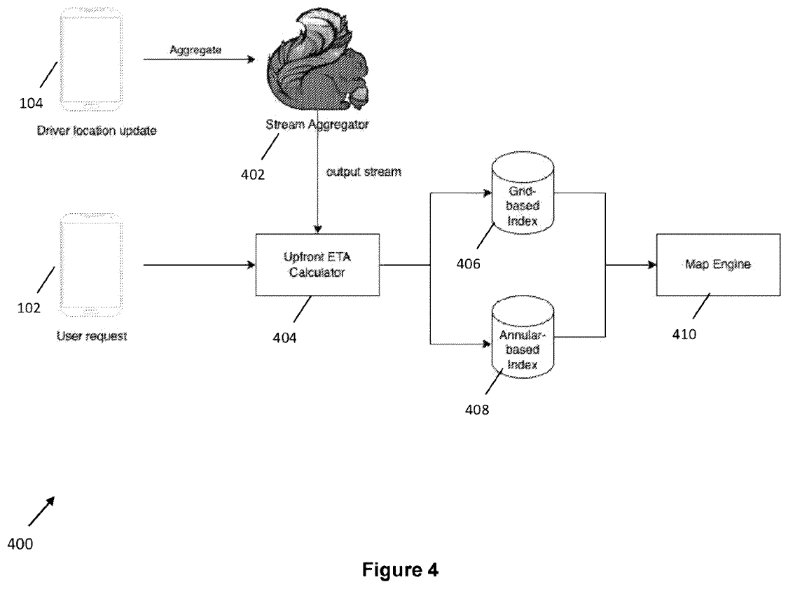

The estimation server 140 may comprise a stream module 262 that is configured for aggregating information relating to at least a location and a status of a driver from each of a plurality of provider devices 104 that are located within a defined search area that is divided into a plurality of cells. The information may be retrieved via a stream of data comprising driver location updates sent from each provider device 104. For example, the stream module 262 may be configured to determine a number of provider devices 104 located in each cell of the plurality of cells based on a location of each provider device of a plurality of provider devices 104, each provider device 104 being a computing device associated with a driver located within the search area. retrieving information from each provider device of the plurality of provider devices indicating a location and a status of the provider device. The stream module 262 may be further configured to determine an eligibility of each provider device based on the status, and update the number of provider devices based on the location of each provider device that is determined to be eligible. The stream process is further explained in FIG. 4.

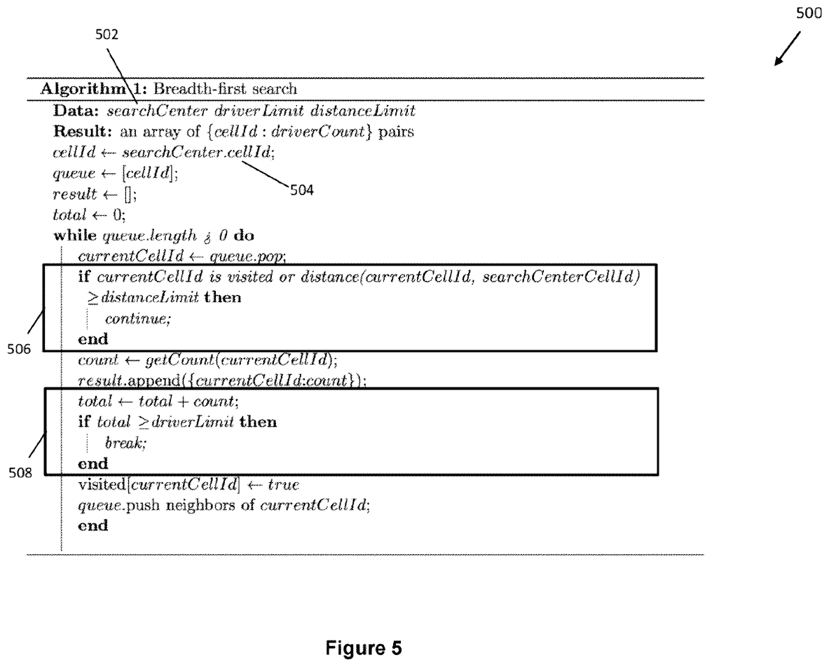

The estimation server 140 may also comprise a calculation module 264 that is configured for identifying one or more cells of the plurality of cells based on the relative distance and a threshold, wherein a total number of provider devices 104 located in the one or more cells do not exceed the threshold. The calculation module 264 may be further configured for identifying one or more cells having at least one number of provider device based on a breadth-first search, the breadth search being based on the relative distance and the threshold, wherein a total number of drivers located in the one or more cells do not exceed the threshold. The calculation process is further explained in FIGS. 4 and 5.

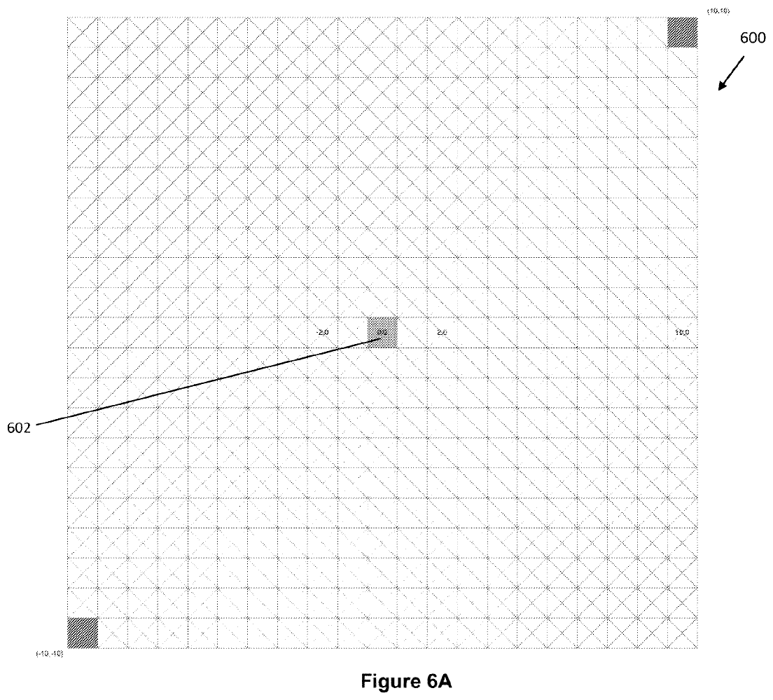

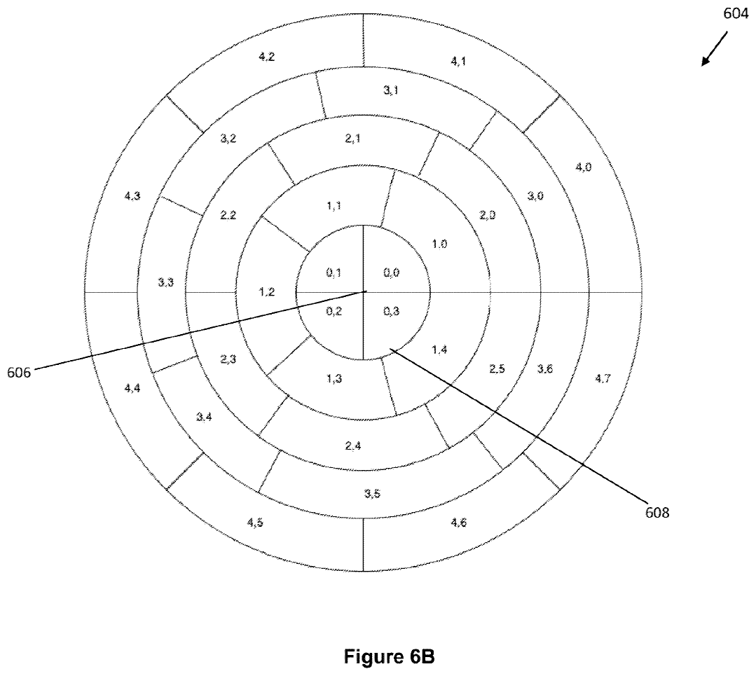

The estimation server 140 may also comprise a map module 266 that is configured for defining a search area divided into a plurality of cells, the search area having a location as a centre point of the search area, the location being indicated in a request for a driver from a requestor device 102, the requestor device 102 being a computing device associated with a user. In an implementation, the search area may be a square grid, and defining the search area may further comprise defining each cell of the plurality of cells with an index based on a relative spatial location of each cell with the location. In another implementation, the search area may be a circular grid, and defining the search area may further comprise defining each cell of the plurality of cells with an index based on a relative distance and angle of each cell with the location. The map module 266 may be further configured for defining a size of each cell to be proportional to a relative distance between each cell and the centre point of the search area. The map defining process is further explained in FIGS. 4, 6A and 6B.

The estimation server 140 may also comprise an estimation module 268 that is configured for estimating, in real time and in response to the request for a driver, a time of arrival of a driver at the location based on a relative distance between the location and the plurality of cells based on the determined number of provider devices 104. In an implementation, the estimation module 268 may be further configured for calculating an estimated time of arrival value for each of the one or more cells based on the relative distance, and calculating a weighted average of the calculated estimated time of arrival values based on the determined number of provider devices located in each cell of the one or more cells. In another implementation, the estimation module 268 may be configured for calculating an estimated time of arrival value for each of the one or more cells based on the relative distance, sorting the estimated time of arrival values in ascending order, and determining the time of arrival based on a percentile of the sorted values. The estimation process is further explained in FIG. 4.

Each of the data module 260, stream module 262, calculation module 264, map module 266 and estimation module 268 may further be in communication with a processing module (not shown) of the estimation server 140, for example for coordination of respective tasks and functions during the process. The data module 260 may be further configured to communicate with and store data and information for each of the processing module, stream module 262, calculation module 264, map module 266 and estimation module 268. Alternatively, all the tasks and functions required for adaptively estimating a time of arrival of a driver at a location may be performed by a single processor of the estimation server 140.

FIG. 4 illustrates an overview of a system for estimating a time of arrival of a driver at a location according to various embodiments. A Stream Aggregator 402 may be configured to receive information comprising at least driver location updates (e.g., GPS information, latitudinal and longitudinal coordinates, geohash information, or other similar information) and driver status updates (e.g., available, unavailable, handling another request, finishing a request soon, or other similar statuses) sent from each driver's provider device 104 of a plurality of provider devices 104. Each of the plurality of provider devices 104 may be located within a search area that is defined based on a location that is indicated in a request for a driver that is received from the requestor device 102. The Stream Aggregator 402 may then perform the following steps to aggregate a final result. In a first step, each location update is filtered based on certain criteria, for example the status received for each driver (e.g., only drivers with ‘available’ status are considered, or other criteria depending on application). In a second step, each driver location update is mapped to a corresponding cell (e.g., each cell being identified by a corresponding Cell ID) of a plurality of cells that make up the search area, divided by geohash or a first N digits of latitude and longitude. In a third step, a total count of eligible drivers (e.g., DriverCount) in each cell are summed in a short time window. In a fourth step, a result stream is output as {Cell ID: DriverCount} pairs for further processing.

An Upfront ETA Calculator 404 may be configured to receive the output stream from the Stream Aggregator 402 and store all pairs in a lookup table. The lookup table may be stored locally within a memory of the Upfront ETA Calculator 404, or stored in the reference database 150. Upon receiving a request for a driver from a requestor device 102, the Upfront ETA Calculator 404 may be configured to perform a breadth-first search. An example of a breadth-first algorithm that may be utilized by the Upfront ETA Calculator 404 is shown in illustration 500 of FIG. 5. For example, the bread-first search may be performed until the search criteria are met, for example until a targeted number of drivers are found for calculating an ETA (e.g., as shown in reference 508) and until a limit of a relative distance between a cell and the location (e.g., indicated as searchCenter 502 and identified with an identifier searchCenter.cellId 504) is reached (e.g., as shown in reference 506).

For each non-empty cell, the Upfront ETA Calculator 404 fetches the ETA value from either one of two caches, or an ETA calculating engine. The final ETA result may be, for example,

$$ETA = \frac{{\sum }_{i = 0}^{n} {count}_{i} * {ETA}_{i}}{{\sum }_{i = 0}^{n} {count}_{i}}$$

as a weighted average, where countᵢ denotes the total count of drivers in a cell i, and ETAᵢ denotes the ETA of cell i. In an implementation, the ETA results for all non-empty cells of the plurality of cells may be sorted in ascending order and the final ETA result may be taken as a percentile, for example the 25th or 50th percentile of all

$${\sum }_{i = 0}^{n} {count}_{i}$$

results. The estimation is performed in real time and in response to the request for a driver.

The search area may be defined by a map engine 410. The search area may be in a form of a grid as shown in illustration 600 of FIG. 6A, such that a Grid-based Index 406 is utilized for defining each cell of the plurality of cells that make up the search area. In illustration 600, the search area is divided into a plurality of small grids (e.g., equivalent to the plurality of cells). For example, for a 5 km*5 km search area, using geohash 7, each grid would be 152.9 m*152.4 m; using the first 3 digits of latitude and longitude, each grid would be 100 m*100 m as 0.001° covers 100 m. Using the first 3 digits truncation method as an example, Grid-based Index 406 may divide the search area into a plurality of grids of the same latitudinal longitudinal (LatLng) interval as shown in illustration 600.

A unique identifier of a grid is the latitude and longitude coordinate of the center point of this grid. There may be two kinds of grid index: absolute grid index and relative grid index. The absolute grid index is able to encode an arbitrary point. For example, assuming that an absolute grid index code is 1.324, 103.807, the LatLng interval of this grid is 0.001° since there are 3 decimal places, and this grid refers to an area with latitude interval of [1.324, 1.325) and longitude interval of [103.807, 103.808).

The relative grid index must be associated with a centre point 602. Given the location indicated in the request for a driver from the requestor device 102 as centre point 602 of the search area, and a driver location, latDiff and lngDiff values may be calculated as the difference between the latitude/longitude of the driver location and that of the centre point 602. Then the two spatial codes would be latDiff/IngDiff divided and rounded by a precision. For example, if the precision is 0.001°, the location indicated in the request for a driver is 1.324, 103.807, and there are two drivers A and B at point 1.32725, 103.80301 and 1.32113, 103.80914 respectively, the grid index code of driver A is (3, −4), and the code of driver B is (−3, 2). Advantageously, using the relative grid index to encode a driver's location only takes up 2 bytes, improving data storage and computation efficiency.

In an implementation, a grid-based index may work with Stream Aggregator 402 and map engine 410 based on the following steps:
Step a: Upon receiving a location of a driver, the Stream Aggregator 402 removes the driver identifier, and aggregates the driver to a cell. The cell may be defined by geohash, or a first N digits of latitude and longitude. Then at a certain interval, the Stream Aggregator 402 emits {cellID: driverCount} pairs which may be stored in the Reference Database 150.
Step b: When a request for a driver is received, the Upfront ETA Calculator 404 first finds all nearby cell IDs based on the center location. The cells may be organized in a way which is similar to the one in Step a. Then for each cell, it fetches the corresponding ETA value stored in cache. The cache key is identified by the grid-based index. If an entry does not exist in cache, the Upfront ETA Calculator 404 will call the map engine 410 to calculate ETA from a current cell center to a requested center. The result will then be stored in cache.
Step c: The final ETA may be a weighted average based on the count of drivers in each cell from Step a, multiplying the ETA in each cell from step b, as shown in the formula

$$ETA = \frac{{\sum }_{i = 0}^{n} {count}_{i} * {ETA}_{i}}{{\sum }_{i = 0}^{n} {count}_{i}}$$

as a weighted average, where countᵢ denotes the total count of drivers in a cell i, and ETAᵢ denotes the ETA of cell i.

The search area may also be in a form of a circle as shown in illustration 604 of FIG. 6B, such that an Annular-based Index 408 is utilized for defining each cell of the plurality of cells that make up the search area. An annular index refers to a polar coordinate system, and the index also needs to be associated with an origin point e.g., centre point 606. Given the location indicated in the request for a driver from the requestor device 102 as the centre point 606, and a driver location, a 2-digit spatial code may be calculated for each driver consisting of a distance from the driver location to the centre point 606 divided by a distance precision, and an angle between the two points divided by an angle precision. In an implementation based on illustration 604, the distance precision is 100 m and the angle precision for innermost ring 608 is divided by 90° such that the innermost ring 608 is split into 4 zones. The number of zones thereafter is increased by 1 for each ring after the innermost ring 608. For example, a distance from the centre point 606 to a driver A may be 213 m and angle is 97°, a distance from a driver B to the centre point 606 may be 392 m and angle is 108°, a distance code of driver A is 2 with angle code 97/(4+2)=16, and the distance code of driver B is 3 with angle code 108/(4+3)=15. Therefore, an annular index code for driver A (e.g., equivalent to a cell ID of a cell in which the driver A is located) is (2, 16), and the annular index code for driver B (e.g., equivalent to a cell ID of a cell in which the driver B is located) is (3, 21). Advantageously, using the annular grid index to encode a driver's location only takes up 2 bytes, improving data storage and computation efficiency.

As can be seen visually, the Annular-based Index of illustration 604 is less granular than the Grid-based Index of illustration 600, especially for the outer rings of illustration 604. The logic behind this is, as the distance between a ring and the centre point 608 grows longer, road network and real time traffic would become increasingly dominant factors for calculating ETAs. The size of each cell may thus be defined to be proportional to a relative distance between each cell and the centre point of the search area. It will be appreciated that the search area may also be a square (e.g., as shown in illustration 600), rectangle, polygon or other similar shape.

In an implementation, a circle grid-based index may work with Stream Aggregator 402 and map engine 410 based on the following steps:
Step a: Upon receiving a location of a driver, the Stream Aggregator 402 removes the driver identifier, and aggregates the driver to a cell. The cell may be defined by geohash, or a first N digits of latitude and longitude. Then at a certain interval, the Stream Aggregator 402 emits {cellID: driverCount} pairs which may be stored in the Reference Database 150.
Step b: When a request for a driver is received, the Upfront ETA Calculator 404 first finds all nearby cell IDs based on the center location. The cells may be organized in a way which is similar to the one in Step a. Then for each cell, it fetches the corresponding ETA value stored in cache. The cache key is identified by getting the distance and angle of a current cell center which forms a circle grid index. If an entry does not exist in cache, the Upfront ETA Calculator 404 will call the map engine 410 to calculate ETA from a current cell center to a requested center. The result will then be stored in cache.
Step c: The final ETA may be a weighted average based on the count of drivers in each cell from Step a, multiplying the ETA in each cell from step b, as shown in the formula

$$ETA = \frac{{\sum }_{i = 0}^{n} {count}_{i} * {ETA}_{i}}{{\sum }_{i = 0}^{n} {count}_{i}}$$

as a weighted average, where count denotes the total count of drivers in a cell i, and ETAᵢ denotes the ETA of cell i.

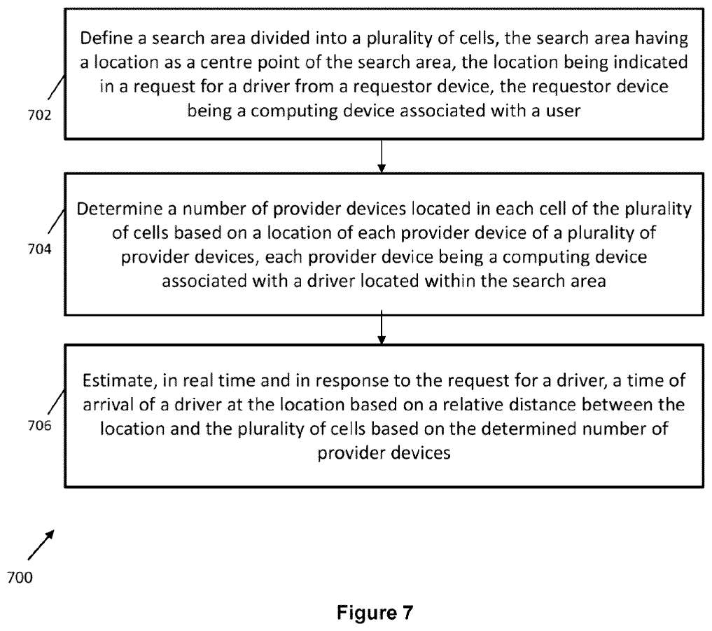

FIG. 7 illustrates an example flow diagram for a method 700 for estimating a time of arrival of a driver at a location according to various embodiments. In a step 702, a search area divided into a plurality of cells is defined, the search area having a location as a centre point of the search area, the location being indicated in a request for a driver from a requestor device, the requestor device being a computing device associated with a user. In a step 704, a number of provider devices located in each cell of the plurality of cells is determined based on a location of each provider device of a plurality of provider devices, each provider device being a computing device associated with a driver located within the search area. In a step 706, a time of arrival of a driver at the location is estimated, in real time and in response to the request for a driver, based on a relative distance between the location and the plurality of cells based on the determined number of provider devices.

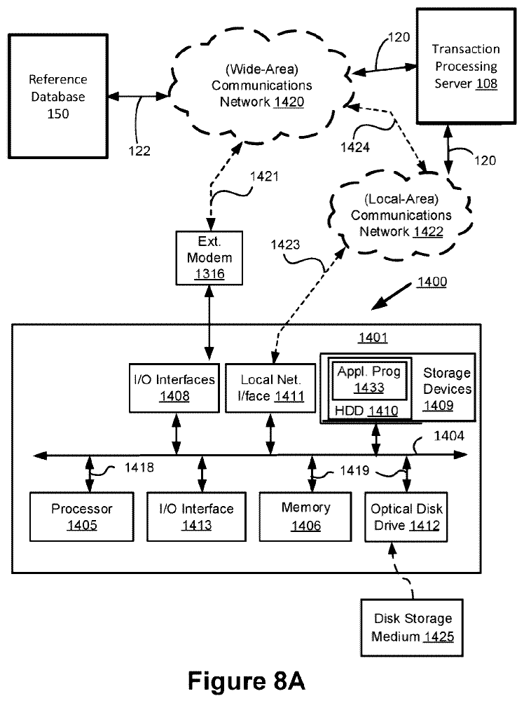

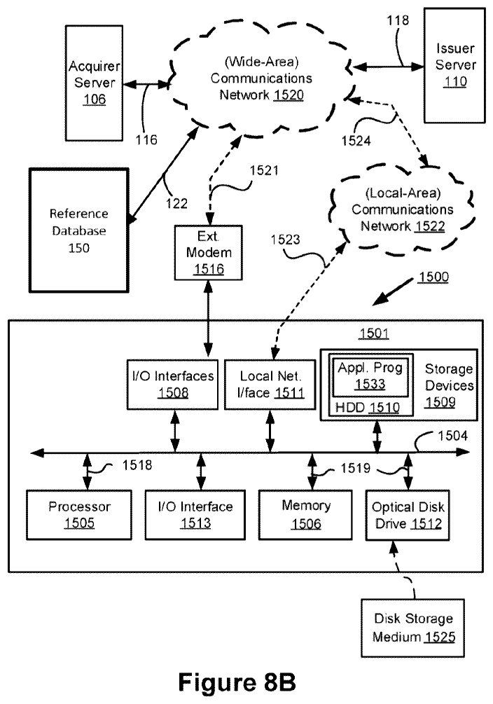

FIG. 8A depict an example computer system 1400, in accordance with which the estimation server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 700, where performed by the estimation server 140 may be implemented using the computer system 1400. The processes may be implemented as one or more software application programs 1433 executable within the computer system 1400. In particular, the method 700 is effected by instructions in the software 1433 that are carried out within the computer system 1400. The software instructions may be formed as one or more code modules, each for performing one or more particular tasks. The software may also be divided into two separate parts, in which a first part and the corresponding code modules performs the method 700 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for an estimation server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for an estimation server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the estimation server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

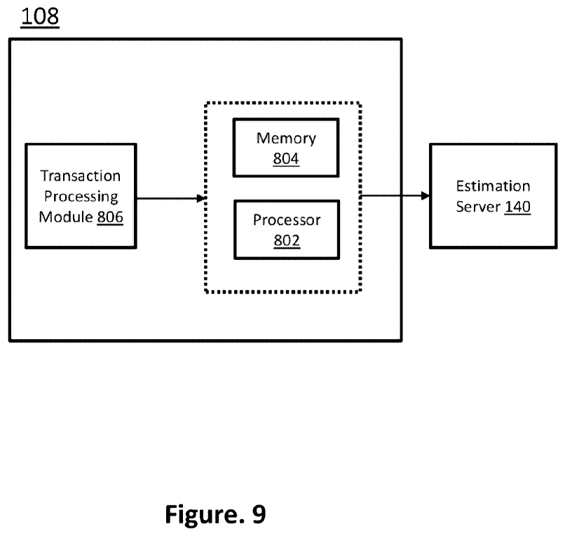

FIG. 9 shows an implementation of the transaction processing server 108 (i.e., the computer system 1300). In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 700. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, a request for a driver, or other similar messages. The transaction processing module 806 may be configured to process processes relating to a transaction by, for example, forwarding data and information associated with the transaction to the other servers in the system 100 such as the estimation server 140. For example, the transaction processing server 108 may, instead of the requestor device 102 or provider device 104, transmit data relating to a request message such as a request for a driver (e.g. date, time, a location, and other similar data) to the estimation server 104. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods.

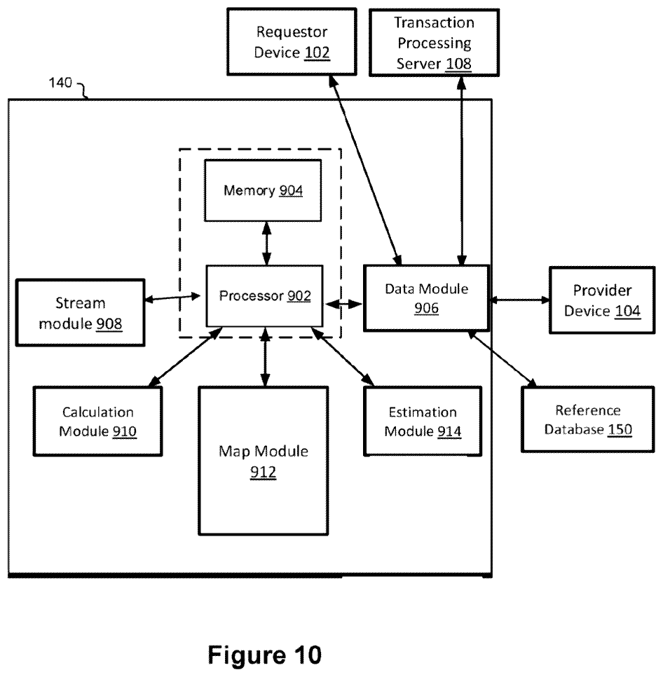

FIG. 10 shows an alternative implementation of the estimation server 140 (i.e., the computer system 1400). In the alternative implementation, estimation server 140 may be generally described as a physical device comprising at least one processor 902 and at least one memory 904 including computer program codes. The at least one memory 904 and the computer program codes are configured to, with the at least one processor 902, cause the estimation server 140 to perform the operations described in the method 700. The estimation server 140 may also include a data module 906, a stream module 908, a calculation module 910, a map module 912 and an estimation module 914. The memory 904 stores computer program code that the processor 902 compiles to have each of the modules 906 to 914 performs their respective functions.

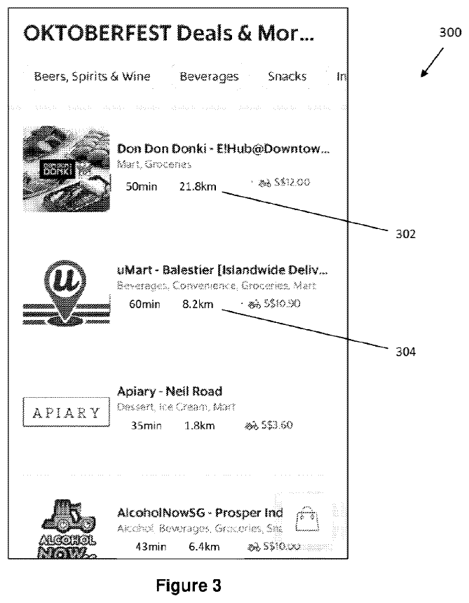

With reference to FIGS. 1 to 7, the stream module 908 performs the function of aggregating information relating to at least a location and a status of a driver from each of a plurality of provider devices 104 that are located within a defined search area that is divided into a plurality of cells. The information may be retrieved via a stream of data comprising driver location updates sent from each provider device 104. For example, the stream module 908 may be configured to determine a number of provider devices 104 located in each cell of the plurality of cells based on a location of each provider device of a plurality of provider devices 104, each provider device 104 being a computing device associated with a driver located within the search area. retrieving information from each provider device of the plurality of provider devices indicating a location and a status of the provider device. The stream module 908 may be further configured to determine an eligibility of each provider device based on the status, and update the number of provider devices based on the location of each provider device that is determined to be eligible.

With reference to FIGS. 1 to 7, the calculation module 910 performs the function of identifying one or more cells of the plurality of cells based on the relative distance and a threshold, wherein a total number of provider devices 104 located in the one or more cells do not exceed the threshold. The calculation module 264 may be further configured for identifying one or more cells having at least one number of provider device based on a breadth-first search, the breadth search being based on the relative distance and the threshold, wherein a total number of drivers located in the one or more cells do not exceed the threshold.

With reference to FIGS. 1 to 7, the map module 912 performs the function of defining a search area divided into a plurality of cells, the search area having a location as a centre point of the search area, the location being indicated in a request for a driver from a requestor device 102, the requestor device 102 being a computing device associated with a user. In an implementation, the search area may be a square grid, and defining the search area may further comprise defining each cell of the plurality of cells with an index based on a relative spatial location of each cell with the location. In another implementation, the search area may be a circular grid, and defining the search area may further comprise defining each cell of the plurality of cells with an index based on a relative distance and angle of each cell with the location. The map module 266 may be further configured for defining a size of each cell to be proportional to a relative distance between each cell and the centre point of the search area.

With reference to FIGS. 1 to 7, the estimation module 914 performs the function of estimating, in real time and in response to the request for a driver, a time of arrival of a driver at the location based on a relative distance between the location and the plurality of cells based on the determined number of provider devices 104. In an implementation, the estimation module 268 may be further configured for calculating an estimated time of arrival value for each of the one or more cells based on the relative distance, and calculating a weighted average of the calculated estimated time of arrival values based on the determined number of provider devices located in each cell of the one or more cells. In another implementation, the estimation module 268 may be configured for calculating an estimated time of arrival value for each of the one or more cells based on the relative distance, sorting the estimated time of arrival values in ascending order, and determining the time of arrival based on a percentile of the sorted values.

With reference to FIGS. 1 to 7, the data module 906 performs the functions of receiving data and information from the requestor device 102, provider device 104, transaction processing server 108, reference database 150, a cloud and other sources of information to facilitate the method 700. For example, the data module 906 may be configured to receive data and information required for processing stream information, defining search areas, perform arrival time estimation calculations, and other similar processes from the requestor device 102, the provider device 104, transaction processing server 108, reference database 150, and/or other sources of information. The data module 260 may be further configured to send information relating to data retrieved in response to the request for a driver to the requestor device 102, the provider device 104, the transaction processing server 108, or other destinations where the information is required.

FIG. 8B depicts a general-purpose computer system 1500, upon which a combined transaction processing server 108 and estimation server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 700 performed by the estimation server 140 and facilitated by the transaction processing server 108 may be implemented using the computer system 1500. For example, the steps of the method 700 as performed by the estimation server 140 may be implemented as one or more software application programs 1533 executable within the computer system 1500. In particular, the steps of the method 700 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the method 700 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and estimation server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and estimation server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., combined transaction processing and estimation server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

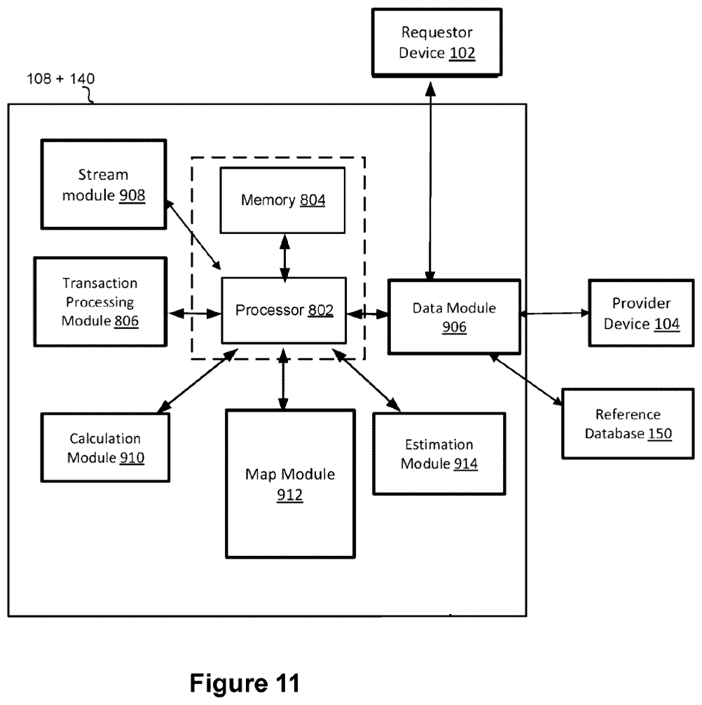

FIG. 11 shows an alternative implementation of combined transaction processing and estimation server (i.e., the computer system 1500). In the alternative implementation, the combined transaction processing and estimation server may be generally described as a physical device comprising at least one processor 1002 and at least one memory 904 including computer program codes. The at least one memory 1004 and the computer program codes are configured to, with the at least one processor 1002, cause the combined transaction processing and estimation server to perform the operations described in the steps of the method 700. The combined transaction processing and estimation server may also include a transaction processing module 806, a data module 906, a detection module 908, an association module 910, a clustering module 912 and an identification module 914. The memory 1004 stores computer program code that the processor 1002 compiles to have each of the modules 806 to 912 performs their respective functions. The transaction processing module 806 performs the same functions as described for the same transaction processing module in FIG. 9. The data module 906, stream module 908, calculation module 910, map module 912 and estimation module 914 perform the same functions as described for the same corresponding modules in FIG. 10.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

What is claimed is:

1. A method for estimating a time of arrival of a driver at a location comprising:
defining, by a server, a search area divided into a plurality of cells, the search area having a location as a centre point of the search area, the location being indicated in a request for a driver from a requestor device, the requestor device being a computing device associated with a user;
determining, by the server, a number of provider devices located in each cell of the plurality of cells based on a location of each provider device of a plurality of provider devices, each provider device being a computing device associated with a driver located within the search area; and
estimating, by the server in real time and in response to the request for a driver, a time of arrival of a driver at the location based on a relative distance between the location and the plurality of cells based on the determined number of provider devices.

2. The method of claim 1, wherein estimating the time of arrival of the driver at the location further comprises identifying one or more cells of the plurality of cells based on the relative distance and a threshold, wherein a total number of provider devices located in the one or more cells do not exceed the threshold.

3. The method of claim 2, wherein estimating the time of arrival of the driver at the location further comprises:
calculating an estimated time of arrival value for each of the one or more cells based on the relative distance, and
calculating a weighted average of the calculated estimated time of arrival values based on the determined number of provider devices located in each cell of the one or more cells.

4. The method of claim 2, wherein estimating the time of arrival of the driver at the location further comprises:
calculating an estimated time of arrival value for each of the one or more cells based on the relative distance,
sorting the estimated time of arrival values in ascending order, and
determining the time of arrival based on a percentile of the sorted values.

5. The method of claim 1, wherein the search area is a square grid, and defining the search area further comprises defining each cell of the plurality of cells with an index based on a relative spatial location of each cell with the location.

6. The method of claim 1, wherein the search area is a circular grid, and defining the search area further comprises defining each cell of the plurality of cells with an index based on a relative distance and angle of each cell with the location.

7. The method of claim 6, further comprising defining a size of each cell to be inversely proportional to a relative distance between each cell and the centre point of the search area.

8. The method of claim 1, wherein determining the number of provider devices in each cell further comprises:
retrieving information from each provider device of the plurality of provider devices indicating a location and a status of the provider device;
determining an eligibility of each provider device based on the status, and updating the number of provider devices based on the location of each provider device that is determined to be eligible.

9. The method of claim 1, further comprising identifying one or more cells having at least one number of provider device based on a breadth-first search, the breadth search being based on the relative distance and a threshold, wherein a total number of drivers located in the one or more cells do not exceed the threshold.

10. A system for estimating a time of arrival of a driver at a location, comprising:
at least one processor; and
at least one memory including computer program code;
the at least one memory and the computer program code configured to, with the at least one processor, cause the system at least to:
define a search area divided into a plurality of cells, the search area having a location as a centre point of the search area, the location being indicated in a request for a driver from a requestor device, the requestor device being a computing device associated with a user;
determine a number of provider devices located in each cell of the plurality of cells based on a location of each provider device of a plurality of provider devices, each provider device being a computing device associated with a driver located within the search area; and
estimate, in real time and in response to the request for a driver, a time of arrival of a driver at the location based on a relative distance between the location and the plurality of cells based on the determined number of provider devices.

11. The system of claim 10, wherein estimating the time of arrival of the driver at the location further comprises identifying one or more cells of the plurality of cells based on the relative distance and a threshold, wherein a total number of provider devices located in the one or more cells do not exceed the threshold.

12. The system of claim 11, wherein estimating the time of arrival of the driver at the location further comprises:
calculating an estimated time of arrival value for each of the one or more cells based on the relative distance, and
calculating a weighted average of the calculated estimated time of arrival values based on the determined number of provider devices located in each cell of the one or more cells.

13. The system of claim 11, wherein estimating the time of arrival of the driver at the location further comprises:
calculating an estimated time of arrival value for each of the one or more cells based on the relative distance,
sorting the estimated time of arrival values in ascending order, and determining the time of arrival based on a percentile of the sorted values.

14. The system of claim 10, wherein the search area is a square grid, and defining the search area further comprises defining each cell of the plurality of cells with an index based on a relative spatial location of each cell with the location.

15. The system of claim 10, wherein the search area is a circular grid, and defining the search area further comprises defining each cell of the plurality of cells with an index based on a relative distance and angle of each cell with the location.

16. The system of claim 15, further configured to define a size of each cell to be inversely proportional to a relative distance between each cell and the centre point of the search area.

17. The system of claim 10, wherein determining the number of provider devices in each cell further comprises:
retrieving information from each provider device of the plurality of provider devices indicating a location and a status of the provider device;
determining an eligibility of each provider device based on the status, and updating the number of provider devices based on the location of each provider device that is determined to be eligible.

18. The system of claim 10, further configured to identify one or more cells having at least one number of provider device based on a breadth-first search, the breadth search being based on the relative distance and a threshold, wherein a total number of drivers located in the one or more cells do not exceed the threshold.
